(19) United States
(12) Patent Application Publication
(10) Pub. No.: US 2019/0050962 A1
(43) Pub. Date: Feb. 14, 2019

(54) DISPLAY CONTROL SYSTEM AND DISPLAY CONTROL METHOD

(71) Applicant: MStar Semiconductor, Inc., Hsinchu Hsien (TW)

(72) Inventor: Hung-Chi Huang, Hsinchu Hsien (TW)

(21) Appl. No.: 15/850,397

(22) Filed: Dec. 21, 2017

(30) Foreign Application Priority Data
Aug. 11, 2017 (TW) 106127196

(51) Int. Cl. G06T 3/40; G09G 5/14; G09G 5/00

(52) U.S. Cl. CPC G06T 3/4092; G09G 5/14; G09G 2360/18; G09G 2340/0407; G09G 5/005

(57) ABSTRACT

A display control device, receiving a first image and a second image, includes: a scaler, scaling the first image according to a first scaling ratio to form a first scaled image; a frame buffer, storing the first scaled image and the second image, wherein the second image is not scaled; and a display controller, transmitting a combined image according to the first scaled image and the second image in the frame buffer to a display device.

This application claims the benefit of Taiwan application Serial No. 106127196, filed on Aug. 11, 2017, the subject matter of which is incorporated herein by reference.

### BACKGROUND OF THE INVENTION

### Field of the Invention

The invention relates to a display control device and a display control method, and more particularly to a display control device and a display control method providing a multi-picture display function.

### Description of the Related Art

Some current electronic devices provide a multi-picture display function, and are capable of displaying images from different image sources. However, to provide a multi-picture function, an electronic device needs to be provided with multiple scalers, requiring more space as well as higher costs.

### SUMMARY OF THE INVENTION

It is an object of the present invention to provide display control device and method capable of performing a multi-picture function without scaling images.

A display control device receiving a first image and a second image is disclosed according to an embodiment of the present invention. The display control device includes: a scaler, scaling the first image according to a scaling ratio to form a first scaled image; a frame buffer, storing the first scaled image and the second image, wherein the second image is not scaled; and a display controller, transmitting a combined image according to the first scaled image and the second image in the frame buffer to a display device.

A display control method is further disclosed according to another embodiment of the present invention. The display control method includes: scaling a first image according to a first scaling ratio to form a first scaled image; storing the first scaled image and a second image to a frame buffer, wherein the second image is not scaled; and transmitting a combined image according to the first scaled image and the second image in the frame buffer to a display device.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a display control device according to an embodiment of the present invention;

FIG. 2 to FIG. 4 are schematic diagrams of combined images;

FIG. 5 is a flowchart of a scaling ratio determining method according to an embodiment of the present invention;

FIG. 6 is a flowchart of a determining method according to an embodiment of the present invention; and

FIG. 7 is another schematic diagram of an operation of the display control device shown in FIG. 1.

### DETAILED DESCRIPTION OF THE INVENTION

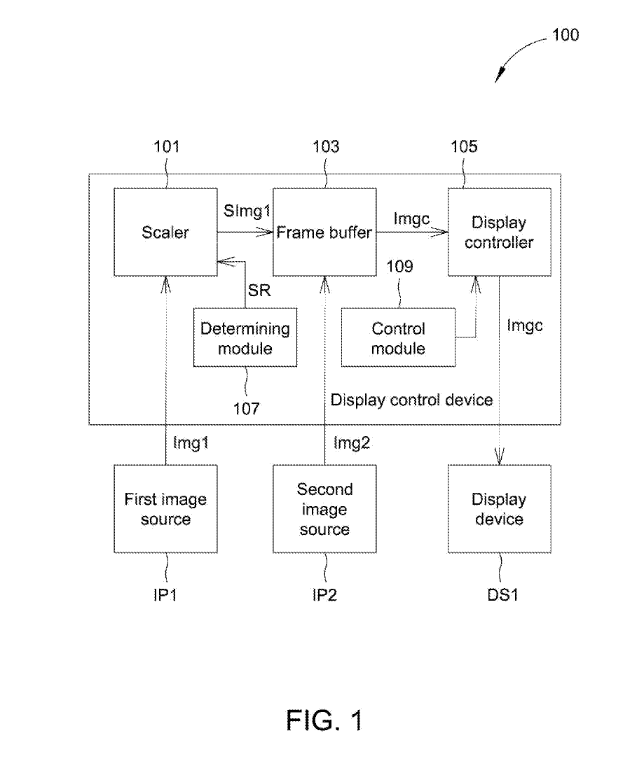

FIG. 1 shows a block diagram of a display control device 100 according to an embodiment of the present invention. The display control device 100 processes a first image Img1 from a first image source IP1 and a second image Img2 from a second image source IP2 to output a combined image Imgc to a display device D1 for display. For example, the first image source IP1 is a television broadcast signal, and the second image source IP2 is a cell phone or another mobile electronic device. The first image Img1 and the second image Img2 may each be an image stream or a still image.

As shown in FIG. 1, the display control device 100 includes a scaler 101, a frame buffer 103 and a display controller 105. The scaler 101 receives the first image Img1 from the first image source IP1, and scales the first image Img1 according to a first scaling ratio SR to form a first scaled image SImg1. The frame buffer 103 receives the first scaled image SImg1, and receives the second image Img2 from the second image source IP2, wherein the second image Img2 is not scaled. The display controller 105 transmits the combined image Imgc according to the first scaled image Simg1 and the second image Img2 to the display device DS1.

It should be noted that, various implementation details of the scaler 101, the frame buffer 103 and the display controller 105 are generally known to one person skilled in the art, and shall be omitted herein for brevity.

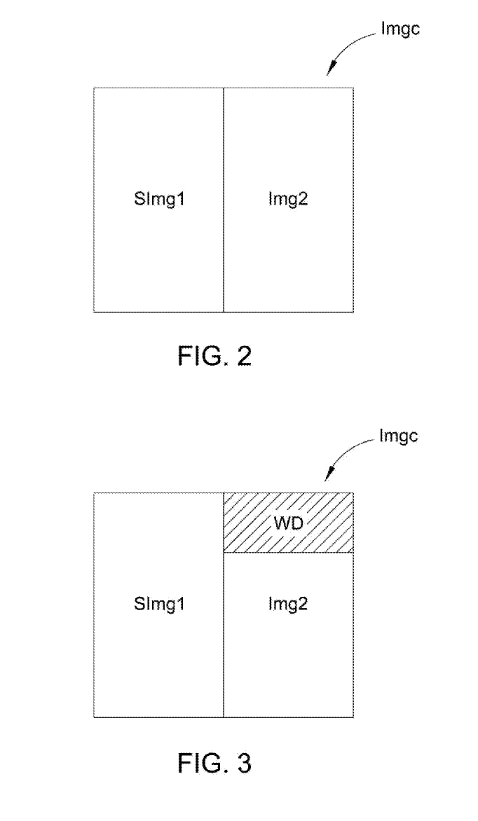

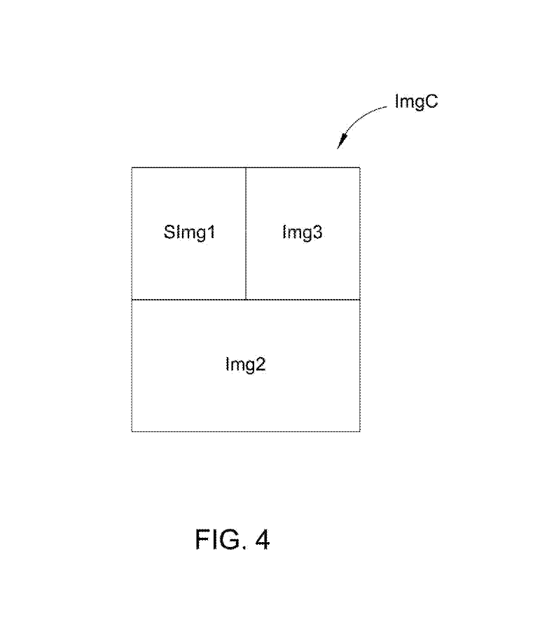

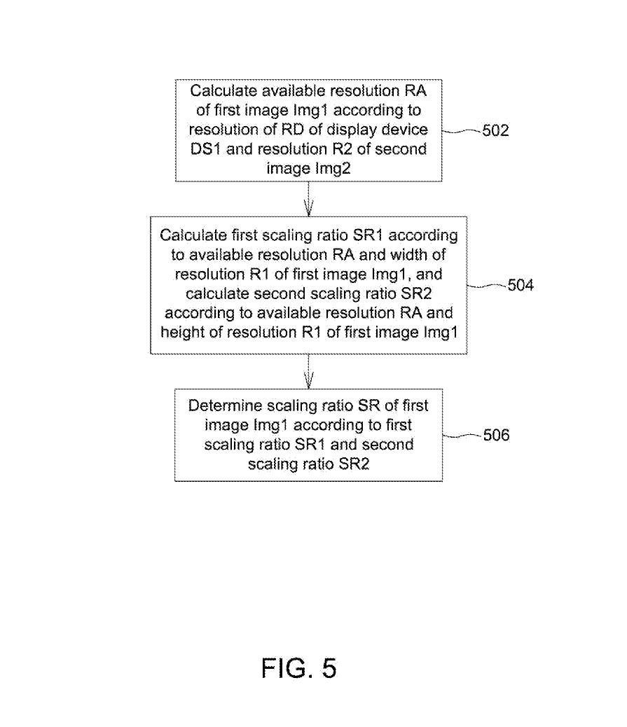

FIG. 2 to FIG. 4 show schematic diagrams of the combined image Imgc. As shown in FIG. 2, the first scaled image SImg1 and the second image Img2 may form a complete combined image Imgc. In the embodiment in FIG. 3, the first scaled image SImg1 and the second image Img2 form only a part of the combined image Imgc, and the combined image Imgc of this embodiment further includes white data WD. Further, the display control device 100 may receive images from more than two image sources for display. For example, in the embodiment in FIG. 5, the display controller 100 further receives a third image Img3 other than the first image Img1 and the second image Img2, and simultaneously displays these images according to the foregoing approach on the display device DS1. The third image Img3 may be a scaled image or a non-scaled image.

Again referring to FIG. 1, in one embodiment, the display control device 100 further includes a determining module 107. The determining module 107 determines the scaling ratio SR of the first image Img1 according to a resolution RD of the display device DS1, a resolution of the first image Img1 and a resolution R2 of the second image Img2. FIG. 5 shows a flowchart of a scaling ratio determining method according to an embodiment of the present invention. Referring to both FIG. 1 and FIG. 5, the determining module 107 calculates an available resolution RA of the first image Img1 according to the resolution RD of the display device DS1 and the resolution R2 of the second image Img2 (step 502). In general, because the width of the resolution RD of the display device DS1 is usually greater than the height, in one embodiment, the determining module 107 may determine the width of the resolution RA according to the width of the resolution RD of the display device DS1 and the width of the resolution R2 of the second image Img2, and further determine the height of the available resolution RA according to the height of the resolution RD of the display device DS1. For example, the resolution RD of the display device DS is 3840*2160, and the resolution R2 of the second image Img2 is 1080*1920. In the above situation, the determining module 107 may subtract the width 1080 of the resolution R2 of the second image Img2 from the width 3840 of the resolution RD of the display device DS1, to determine that the width of the available resolution RA is 2760. The determining module 107 may further determine that the width of the available resolution RA is 2160 according to the height 2160 of the resolution RD of the display device DS1. Therefore, the available resolution RA is 2760*2160.

Next, the determining resolution 107 may calculate a first scaling ratio SR1 according to the widths of the available resolution RA and the resolution R1 of the first image Img1, and calculate a second scaling ratio SR2 according to the heights of the available resolution RA and the resolution R1 of the first image Img1 (step 504). For example, assume that the available resolution RA is 2670*2160, and the resolution R1 of the first image Img1 is 1920*1080. In this situation, the determining module 107 may divide the width 2670 of the available resolution RA by the width 1920 of the resolution R1 of the first image Img1 to calculate the first ratio SR1 as 1.4375. Further, the determining module 107 may divide the height 2160 of the available resolution RA by the height 1080 of the resolution R1 of the first image Img1 to calculate the second scaling ratio SR2 as 2160/1080=2.

The determining module 107 determines the scaling ratio SR of the first image Img1 according to the first scaling ratio SR1 and the second scaling ratio SR2 (step 506). In one embodiment, the scaling ratio SR of the first image Img1 is determined as the smaller between the first scaling ratio SR1 and the second scaling ratio SR2. For example, the first scaling ratio SR1=1.4375, and the second scaling ratio SR2=2. In the above situation, the determining module 107 may determine that the scaling ratio SR of the first image Img1 as 1.4375. In other words, the scaling ratios for both the height and width of the first image Img1 are 1.4375, so as to keep the original length-width ratio of the first image Img1.

In another embodiment, the determining module 107 may determine the scaling ratio SR of the first image Img1 by further considering the scaling capability of the scaler 101. For example, assuming that the scaler provides scaling ratios 1.2, 1.4 and 1.6, because 1.4 is closest to 1.4375, the determining module 107 may determine the scaling ratio SR of the first image Img1 as 1.4.

In another embodiment, the determining module 107 may determine a width scaling ratio SRW of the first image Img1 according to the first scaling ratio SR1, and determine a height scaling ratio SRH of the first image Img1 according to the second scaling ratio SR2. For example, the first scaling ratio SR1=1.4375 and the second scaling ratio SR2=2. In the above situation, the determining module 107 may determine the width scaling ratio SRW of the first image Img1 as 1.4375 and the height scaling ratio SRH of the first image Img1 as 2, so as to maximize the first image Img1.

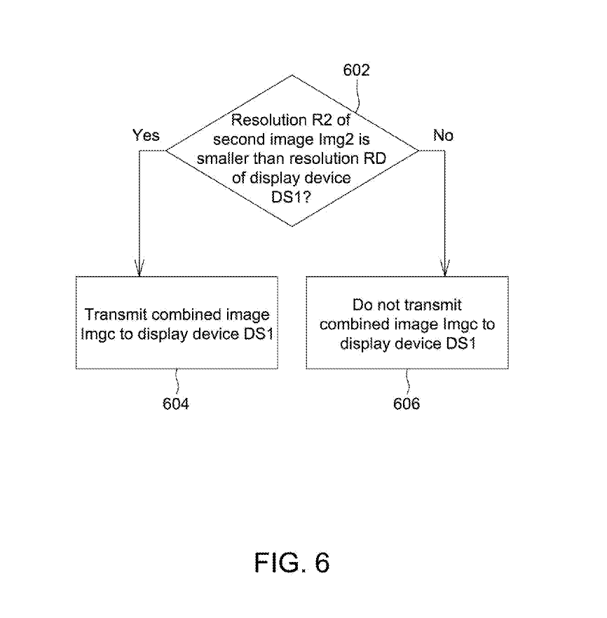

The display control device 100 may further include a control module 109. The control module 109 determines whether the second image Img2 needs to be scaled according to a predetermined resolution and the resolution R2 of the second image Img2. When the control module 109 determines that the second image Img2 does not need to be scaled, the display controller 105 is controlled to transmit the combined image Imgc to the display device DS. FIG. 6 shows a flowchart of a determining method according to an embodiment of the present invention. Referring to FIG. 1 and FIG. 6, in one embodiment, the predetermined resolution is the resolution RD of the display device DS1. The control module 109 determines whether the resolution R2 of the second image Img2 is smaller than the resolution RD of the display device DS1 (step 602). When the control module 109 determines that, according to the resolution R2 of the second image Img2 being smaller than the resolution RD of the display device DS1, the second image Img2 does not need to be scaled and can be displayed on the display device DS1, the control module 109 controls the display controller 105 to transmit the combined image Imgc to the display device DS1 (step 604). Conversely, when the control module 109 determines that, according to the resolution R2 of the second image Img2 being greater than the resolution RD of the display device DS1, the second image Img2 needs to be scaled before it can be displayed on the display device DS1, the control module 109 controls the display controller 105 not to transmit the combined image Imgc to the display device DS1 (step 606).

In one embodiment, the control module 109 determines whether the second image Img2 needs to be scaled according to whether the width of the resolution RD of the display device DS1 is greater than the width of the resolution R2 of the second image Img2, and whether the height of the resolution RD of the display device DS1 is greater than the height of the resolution R2 of the second image Img2. For example, the resolution RD of the display device DS1 is 3840*2160, and the resolution R2 of the second image Img2 is 1080*1920. In this situation, the control module 109 determines that, according to the width 3840 of the resolution RD of the display device DS1 being greater than the width 1080 of the resolution R2 of the second image Img2 and the height 2160 of the resolution RD of the display device DS1 also being greater than the height 1920 of the resolution R2 of the second image Img2, the second image Img2 does not need to be scaled.

In one embodiment, only when the control module 109 determines that the second image Img2 does not need to be scaled, the determining module 107 determines the scaling ratio SR of the first image Img1 according to the resolution RD of the display device DS1, the resolution R1 of the first image Img1 and the resolution R2 of the second image Img2.

The determining module 107 and the control module 109 may be achieved by a processing unit with assistance of software programs. However, the present invention is not limited to the above example, and the determining module 107 and the control module 109 may also be achieved by dedicated hardware circuits.

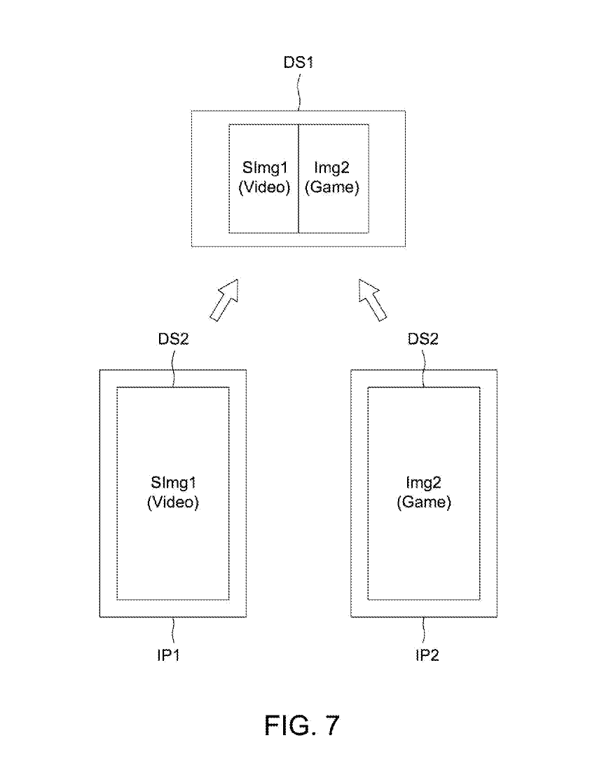

In one embodiment, the first image source IP1 and the second image source IP2 are both electronic devices each including a display device, e.g., computers, cell phones or tablet computers. A user may control the first scaled image SImg1 displayed on the display device DS1 through the first image source IP1, and control the second image Img2 displayed on the display device DS1 through the second image source IP2. FIG. 7 shows an actual application example. In this example, two users respectively hold the first image source IP1 and the second image source IP2 (both being cell phones). The user holding the first image source IP1 wishes to watch a video on the larger display device DS1, and the user holding the second image source IP2 wishes to execute a game on the larger display device DS1. In the above situation, the two users may connect the first image source IP1 and the second image source IP2, via a wired connection (e.g., an HDMI cable) or a wireless connection (e.g., WiFi), to the display device DS1 to respectively watch the video and execute the game. In this embodiment, the user may control rewind and fast-forward operations of the video through the first image source IP1, and execute instructions in the game through the second image source IP2. In the above situation, the first image source IP1 and the second image source IP2 may simultaneously display the first scaled image SImg1 and the second image Img2 on a smaller display device DS2, or the first scaled image SImg1 and the second image Img2 may not be displayed at all.

In conclusion, by disposing only one scaler in the electronic device, the electronic device provides a multi-picture function and also reduces space and costs of scalers.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display control device, receiving a first image and a second image, comprising:
a scaler, scaling the first image according to a scaling ratio to form a first scaled image;
a frame buffer, storing the first scaled image and the second image, wherein the second image is not scaled; and
a display controller, transmitting a combined image according to the first scaled image and the second image in the frame buffer to a display device.

2. The display control device according to claim 1, further comprising:
a determining module, determining the scaling ratio of the first image according to a resolution of the display device, a resolution of the first image and a resolution of the second image.

3. The display control device according to claim 1, further comprising:
a control module, determining whether the second image needs to be scaled according to a predetermined resolution and a resolution of the second image;
wherein, when the control module determines that the second image does not need to be scaled, controls the display controller to transmit the combined image to the display device.

4. The display control device according to claim 3, wherein the predetermined resolution is a resolution of the display device.

5. A display control method, comprising:
scaling a first image according to a scaling ratio to form a first scaled image;
storing the first scaled image and a second image to a frame buffer, wherein the second image is not scaled; and
transmitting a combined image according to the first scaled image and the second image in the frame buffer to a display device.

6. The display control method according to claim 5, further comprising:
determining the scaling ratio of the first image according to a resolution of the display device, a resolution of the first image and a resolution of the second image.

7. The display control method according to claim 5, further comprising:
determining whether the second image needs to be scaled according to a predetermined resolution and a resolution of the second image;
wherein, when it is determined that the second image does not need to be scaled, transmitting the combined image to the display device.

8. The display control method according to claim 5, wherein the predetermined resolution is a resolution of the display device.
